(19) United States
(12) Patent Application Publication
(10) Pub. No.: US 2013/0148352 A1
(43) Pub. Date: Jun. 13, 2013

(54) LED LAMP AND LIGHTING METHOD THEREOF

(71) Applicants: Zhen WANG, Beijing (CN); Yao CHEN, Beijing (CN)

(72) Inventors: Zhen WANG, Beijing (CN); Yao CHEN, Beijing (CN)

(73) Assignee: BEIJING TONLIER ENERGY TECHNOLOGY CO., LTD., Beijing (CN)

(21) Appl. No.: 13/346,746

(22) Filed: Jan. 10, 2012

(30) Foreign Application Priority Data
Dec. 9, 2011 (CN) 201110412837.3

(51) Int. Cl. F21V 5/04; F21V 7/00

(52) U.S. Cl. 362/245; 362/247

(57) ABSTRACT

A Light Emitting Diode (LED) lamp and a lighting method thereof are disclosed. The LED lamp includes at least one LED light source, for emitting light; and a reflective lampshade, including several reflective surfaces, where the reflective surfaces reflect the light emitted by the LED light source onto corresponding lighted areas respectively. The lighted areas have the same illuminance. The LED lamp lighting method includes: at least one LED light source emitting light; and several reflective surfaces of a reflective lampshade reflecting the light emitted by the LED light source onto corresponding lighted areas respectively. The lighted areas have the same illuminance. By employing the present invention, illumination directivity of the LED lamp can be improved dramatically, the glare phenomenon can be eliminated effectively, and uniform lighting of the lighted areas can be achieved.

### FIELD OF THE INVENTION

The present invention relates to the technical field of lighting lamps, and more particularly to a Light Emitting Diode (LED) lamp and a lighting method thereof.

### BACKGROUND OF THE INVENTION

An LED is a solid-state semiconductor device, which can directly convert electricity energy into light. Different from the principles that an incandescent lamp emits light through a tungsten wire and an energy-saving lamp emits light through power of the three primary colors, the LED emits light through an electric field. Compared with a conventional light source, an LED light source has unparalleled advantages as follows. (1) An ultra-long service life. Under a suitable voltage and electric current, the service life is up to 60 thousand to 100 thousand hours, which is more than 10 times longer than the service life of the conventional light source. (2) Being green and environmentally friendly. The light source includes no mercury, incurs no pollution, has the spectrum not including the ultraviolet ray and the infrared ray, incurs neither heat nor radiation, produces less glare, is a cold light source, is safe to touch, and is a typical green lighting source. (3) The LED consumes a very small amount of power, achieves ultra-low power consumption, and saves approximately 80% energy to achieve the same lighting effect compared with the conventional light source. (4) Being small, firm and durable. The LED is completely encapsulated in epoxy resin, and is firmer than a bulb and a fluorescent tube. (5) The LED light source has excellent color rendering performance, and has a color rendering index being greater than 70.

Currently, LED lighting lamps are mainly implemented in two forms. In one form, an LED light source is placed in a conventional lamp. In the other form, LED light sources are uniformly arranged, and light is directly distributed through a lens. However, the two forms cannot eliminate the defects of conventional lighting lamps either. The defects are as follows.

Illumination directivity is poor, and the illuminated area is not obvious. That is to say, a place not required to be illuminated is illuminated. With the total luminous flux being the same, illuminance of a ground effective area is caused to decrease.

The illuminance is not uniform, thereby resulting in brightness in short distances and dimness in long distances. Either the illuminance of an area at a long distance fails to meet the standard, or the illuminance of an area at a short distance far exceeds the standard. The distribution of the illumination is not uniform, so that in order to enable dark areas on two sides of a road or between two adjacent lamps to meet the lighting standard, the prior design has to adopt a light source of greater power and a greater luminous flux to meet illuminance requirements on the dark areas, thereby wasting electrical energy.

If a dazzling light emitting point exists in the field of view, the visual effect is affected, thereby making human eyes uncomfortable. When an elevation angle of a light intensity peak value of a lamp is close to 70°, the lamp is a semi-cut-off lamp, and the glare phenomenon is serious.

### SUMMARY OF THE INVENTION

An embodiment of the present invention provides an LED lamp, so as to improve illumination directivity of the LED lamp and eliminate the glare phenomenon. The LED lamp includes:

at least one LED light source, for emitting light; and

a reflective lampshade, including several reflective surfaces, where the reflective surfaces reflect the light emitted by the LED light source onto corresponding lighted areas respectively.

Preferably, the LED lamp may further include:

a condenser lens, mounted in front of the LED light source, where the light emitted by the LED light source concentrates after passing through the condenser lens.

The reflective lampshade is mounted in front of the condenser lens, and the reflective surfaces are further used to reflect the concentrated light onto the corresponding lighted areas respectively.

Preferably, the condenser lens may further be used to concentrate the light, having the beam angle of 120°, emitted by the LED light source into light having the beam angle of 10°.

Preferably, when the number of the LED light source decreases, a high-power LED light source may be used as the remaining LED light source.

Preferably, the lighted areas have the same illuminance.

An embodiment of the present invention further provides an LED lamp lighting method, so as to improve illumination directivity of the LED lamp and eliminate the glare phenomenon. The method includes:

at least one LED light source emitting light; and

several reflective surfaces of a reflective lampshade reflecting the light emitted by the LED light source onto corresponding lighted areas respectively.

Preferably, the method may further include:

a condenser lens mounted in front of the LED light source concentrating the light emitted by the LED light source; and

the reflective surfaces of the reflective lampshade further reflecting the concentrated light onto the corresponding lighted areas respectively.

Preferably, the condenser lens may further concentrate the light, having the beam angle of 120′, emitted by the LED light source into light having the beam angle of 10°.

Preferably, the method may further include:

when the number of the LED light source decreases, using a high-power LED light source as the remaining LED light source.

Preferably, the lighted areas have the same illuminance.

In the embodiments of the present invention, the reflective surfaces of the reflective lampshade reflect the light emitted by the at least one LED light source onto the corresponding lighted areas respectively, so as to dramatically improve the illumination directivity of the LED lamp, and make the illuminated area obvious without illuminating any place not required to be illuminated. Compared with the LED lamp in the prior art, with the total luminous flux being the same, illuminance of a ground effective area is increased. Meanwhile, an elevation angle of a light intensity peak value is enabled to be about 60°, and light intensity in directions with the elevation angle being 80° and 90° is enabled not to exceed 30 cd/1,000 μm and 10 cd/1,000 μm, thereby resulting in a cut-off lamp, and effectively eliminating the glare phenomenon.

In the embodiments of the present invention, the condenser lens mounted in front of the LED light source is further employed to concentrates the light emitted by the LED light source, the reflective surfaces of the reflective lampshade reflect the concentrated light onto the corresponding lighted areas respectively, so as to further improve the illumination directivity of the LED lamp. A reflection position of the light in the lighted area is precisely controlled, so that the luminous flux outside the lighted areas is very small, thereby preventing light energy from being wasted, and further eliminating the glare phenomenon.

In the embodiments of the present invention, when the number of the LED light source decreases, a high-power LED light source may be used as the remaining LED light source, so that based on the premise that a light distribution effect is ensured, the number of the LED light source may be decreased effectively, thereby providing options in application between the high lighting effect and the low cost.

In the embodiments of the present invention, the lighted areas have the same illuminance, and the bright-at-short-distance and dim-at-long-distance phenomenon is avoided, so as to achieve uniform lighting of the lighted areas. Compared with the LED lamp in the prior art, the electrical energy is prevented from being wasted.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts. In the accompanying drawings:

FIG. 1 is a schematic structural view of an LED lamp according to an embodiment of the present invention;

FIG. 2 is a processing flow chart of an LED lamp lighting method according to an embodiment of the present invention;

FIG. 3 is a schematic view of a specific example of an LED lamp according to an embodiment of the present invention;

FIG. 4 is a schematic view of dividing a ground effectively lighted area into grids according to an embodiment of the present invention;

FIG. 5 is a schematic view of re-divided areas of a grid area according to an embodiment of the present invention; and

FIG. 6 is a schematic distribution view of a luminous flux of a single LED light source according to the embodiment of the present invention.

### DETAILED DESCRIPTION OF THE PREFERRED EMBODIMENTS

In order to make the objectives, technical solutions, and advantages according to embodiments of the present invention more comprehensible, the embodiments of the present invention are described in further detail below with reference to the accompanying drawings. Here, the exemplary embodiments and the illustrations of the present invention are only intended to explain the present invention, rather than to limit the present invention.

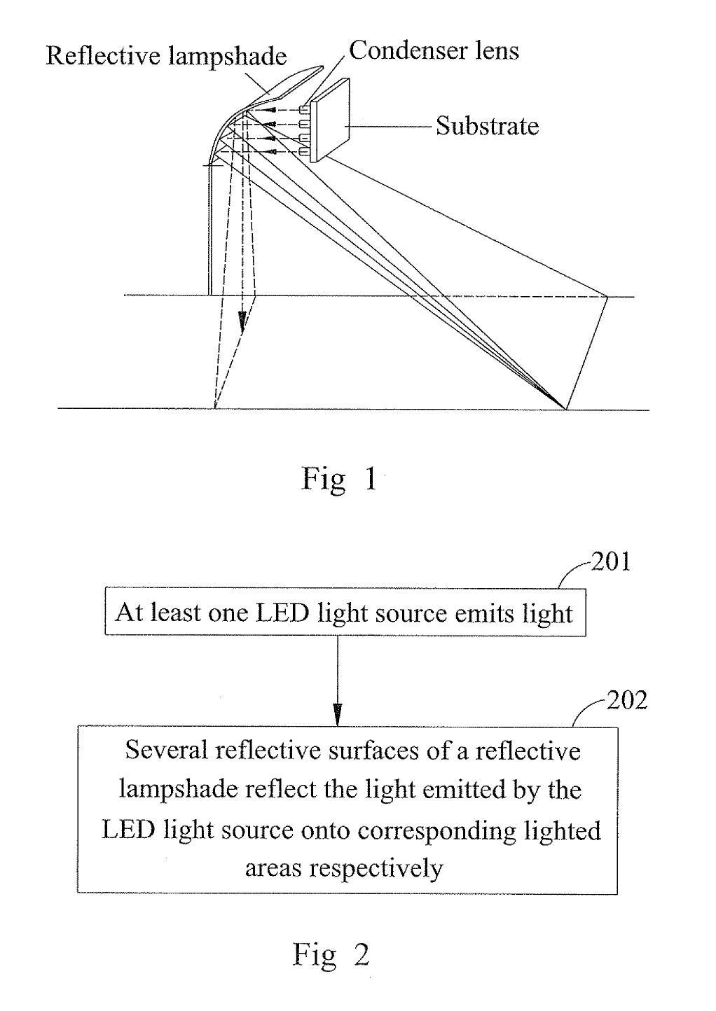

It is noticed by the inventor that the LED lamp technologies in the prior art fail to fully take advantages of strong directivity of LED light, and fail to reasonably and effectively control the direction of the LED light. In order to improve illumination directivity of an LED lamp and eliminate the glare phenomenon, an embodiment of the present invention provides an LED lamp. As shown in FIG. 1, the LED lamp may include:

at least one LED light source, for emitting light; and

a reflective lampshade, including several reflective surfaces, where the reflective surfaces reflect the light emitted by the LED light source onto corresponding lighted areas respectively. The LED light source in FIG. 1 is mounted on a substrate (not shown).

In implementation, the reflective surfaces of the reflective lampshade of the LED lamp reflect the light emitted by the at least one LED light source onto the corresponding lighted areas respectively, so as to dramatically improve the illumination directivity of the LED lamp, and make the illuminated area obvious without illuminating any place not required to be illuminated. Compared with the LED lamp in the prior art, with the total luminous flux being the same, illuminance of a ground effective area is increased. Meanwhile, an elevation angle of a light intensity peak value is enabled to be about 60°, and light intensity in directions with the elevation angle being 80° and 90° is enabled not to exceed 30 cd/1,000 μm and 10 cd/1,000 μm, thereby resulting in a cut-off lamp, and effectively eliminating the glare phenomenon.

As shown in FIG. 1, during specific implementation, the LED lamp of the embodiment of the present invention may further include:

a condenser lens, mounted in front of the LED light source, where the light emitted by the LED light source concentrates after passing through the condenser lens.

The reflective lampshade is mounted in front of the condenser lens. The reflective surfaces are further used to reflect the concentrated light onto the corresponding lighted areas respectively.

In implementation, the condenser lens mounted in front of the LED light source concentrates the light emitted by the LED light source, and the reflective surfaces of the reflective lampshade reflect the concentrated light onto the corresponding lighted areas respectively, so as to further improve the illumination directivity of the LED lamp. A reflection position of the light in the lighted area is precisely controlled, so that the luminous flux outside the lighted areas is very small, thereby preventing light energy from being wasted, and further eliminating the glare phenomenon.

During specific implementation, for example, the condenser lens may further be used to concentrate the light, having the beam angle of 120°, emitted by the LED light source into light having the beam angle of 10°.

During specific implementation, when the number of the LED light source decreases, a high-power LED light source may be used as the remaining LED light source. When several LED light sources are reduced, the power of the rest LED light source is increased, and the luminous flux of the single LED light source is increased, so that average illuminance of the ground effective area remains unchanged, and uniformity of the illuminance remains unchanged. Based on the premise that a light distribution effect is ensured, the number of the LED light source may be decreased effectively, thereby providing options in application between the high lighting effect and the low cost.

During specific implementation, the lighted areas have the same illuminance, and the bright-at-short-distance and dim-at-long-distance phenomenon is avoided, so as to achieve uniform lighting of the lighted areas. Compared with the LED lamp in the prior art, the electrical energy is prevented from being wasted.

An LED lamp lighting method is further provided in an embodiment of the present invention, which is described in the following embodiment. The principles of the method for solving problems are similar to those of the LED lamp, so that the implementation of the LED lamp may serve as a reference for implementation of the method, and the overlapping parts are not repeated hereinafter.

As shown in FIG. 2, the LED lamp lighting method in the embodiment of the present invention may include the following steps.

In Step 201, at least one LED light source emits light.

In Step 202, several reflective surfaces of a reflective lampshade reflect the light emitted by the LED light source onto corresponding lighted areas respectively.

During specific implementation, the method may further include the following.

A condenser lens mounted in front of the LED light source concentrates the light emitted by the LED light source.

The reflective surfaces of the reflective lampshade further reflect the concentrated light onto the corresponding lighted areas respectively.

During specific implementation, the condenser lens may further concentrate the light, having the beam angle of 120°, emitted by the LED light source into light having the beam angle of 10°.

During specific implementation, the method may further include the following.

When the number of the LED light source decreases, a high-power LED light source may be used as the remaining LED light source. When several LED light sources are reduced, the power of the rest LED light source is increased, and the luminous flux of the single LED light source is increased, so that average illuminance of the ground effective area remains unchanged, and uniformity of the illuminance remains unchanged.

During specific implementation, the lighted areas have the same illuminance.

An example is provided below to illustrate specific implementation of the LED lamp and the LED lamp lighting method of the embodiments of the present invention. In the example, it is assumed that the LED lamp has the mounting height of H meters, and is used for road lighting.

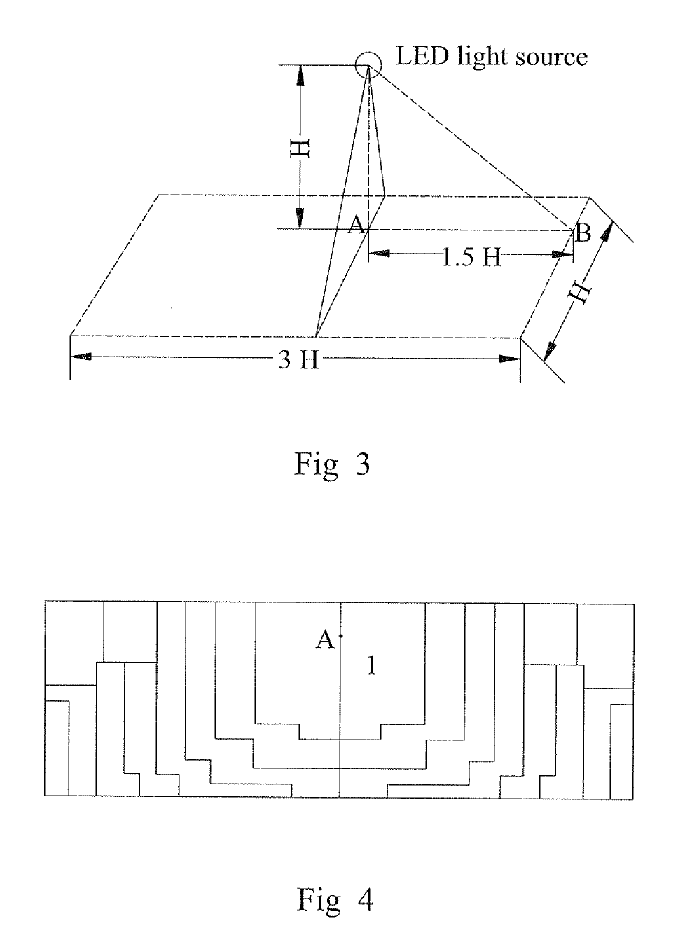

Referring to FIG. 3, a lighting scope of a road lamp is 3.011 meters long in a road length direction and 1.0H meters wide in a road width direction. The LED lamp is bilaterally symmetrical in the road length direction. A location A is just below the LED lamp, a location B is 1.5H meters away from the location A in the road length direction. The degree of attenuation is in direct proportion to a square of the illumination distance, so that with the illumination intensity being the same, the illuminance of a road surface is smaller if the road surface is further away from the light source center of the road lamp. A distance between the location A and the light source center is H meters, so that a distance between the location B and the light source center is 1.8H meters. It is assumed that the illuminance at the location A is 1 lx, the illuminance at the location B is 0.31×. Accordingly, the illuminance of any location within the lighting scope of the LED lamp can be calculated. In the example, in order to enable the location A and the location B to have the same illuminance, the light source luminous flux reflected to the location B is required to be 3 times of the light source luminous flux reflected to the location A. In order to enable the luminous flux to be uniformly distributed in the lighting scope, the luminous flux of the LED light source is required to be distributed according to the illumination distance on the light source, that is, the LED lamp, and reflected to a designated area along a direction, so as to control the light to illuminate the desired area effectively and uniformly.

In order to meet the requirements, in the example, the LED lamp concentrates the light through a first condenser lens according to the directivity feature of the LED light source to change an emission angle of the light source, and achieves the required light control effect through second reflective light control. The LED light source concentrates the light through the condenser lens, and a light emitting angle of the LED light source concentrates. For example, the beam angle of the LED light source is about 120°, and the beam angle may be concentrated to about 10° through the condenser lens. The light illuminates the reflective lampshade, and is reflected by the reflective surfaces of the reflective lampshade, so as to light the ground effective area.

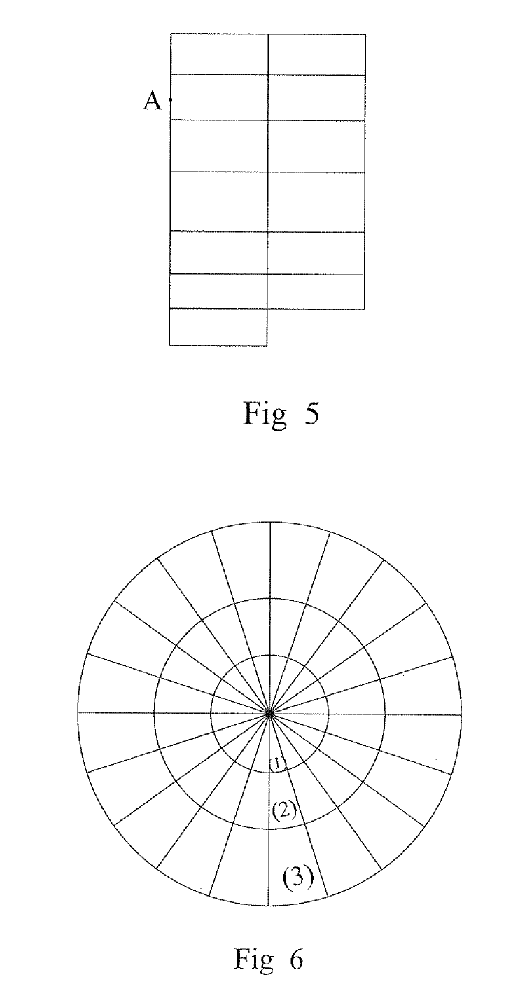

In order to enable the brightness of the ground to be uniform, the luminous flux of the LED light source is required to be distributed reasonably. As shown in FIG. 4, the effectively lighted areas of the ground are divided into grids. The number of the grids is E (E is an integer). The luminous flux of all of the light sources is distributed to the E grid areas uniformly. The attenuation of the luminous flux is in direct proportion to the square of the distance, so that the light source luminous flux required by any grid area can be calculated accordingly. A grid area being further away from the light source center has a smaller area. The location A is just below the LED lamp, so that with the point A being the center, all points in the grid areas have substantially the same distance to the point A. By taking a grid area 1 as an example, it is assumed that the number of the LED light sources is N (N is an integer), and the luminous flux of a single LED light source is T (assuming that T is an integer, the unit is lm, and the power of the single LED light source is 1 W). As shown in FIG. 5, the number of the LED light sources required by the grid area 1 is N/E. The grid area 1 is divided into Z sub-areas uniformly. The luminous flux of all of the LED light sources corresponding to the grid area 1 is divided into Z parts. The Z parts of the luminous flux correspond to the Z sub-areas respectively. Each sub-area receives a part of the luminous flux of the N/E LED light source. The distances between the Z sub-areas and the light source center are calculated. The luminous flux required by the Z sub-areas is calculated. A ratio in percentage of each part of light source luminous flux to the luminous flux of the single LED light source is calculated. The distances between the Z sub-areas and the point A are substantially the same, so that the ratio in percentage of each light source luminous flux to the total luminous flux of the single LED light source is close. FIG. 6 is a schematic distribution view of the luminous flux of the single LED light source. The center of the circle is a light center of the single LED light source. According to light emitting angles of the LED light source, each area may further be divided into three parts, namely, areas (1), (2) and (3). The area (1) is parallel light of the LED light sources. The area (2) is angle light of the LED light sources, and the light emitting angle is 2°. The area (3) is angle light of the LED light sources, and the light emitting angle is 4°. The number of the required LED light sources and the luminous flux are distributed according to the light source luminous flux required by any area on the ground.

In order to achieve uniform brightness of the ground effective area, in the example, the light is then precisely controlled through the reflective surfaces of the reflective lampshade. As shown in FIG. 1, it is assumed that the reflective lampshade is formed by Q (Q is an integer) reflective surfaces, and Q is equal to the product of the number of the LED light sources and the number of the parts of each LED light source. FIG. 1 illustrates the shape of the reflective surfaces of the reflective lampshade. The light included by each part of the LED light source is emitted to the corresponding reflective surface of the reflective lampshade, and is reflected by the reflective surface to light the ground area. According to the light source luminous flux required by any area on the ground, the number of the LED light sources and the luminous flux are distributed. After being concentrated by the condenser lens, the included light is emitted to the reflective surface of the reflective lampshade, and is reflected by the reflective surface of the reflective lampshade, so that the reflection position of the light on the ground is precisely controlled, the luminous flux within the ground effective area is uniformly distributed, and the luminous flux outside the effective area is very small. The uniformity of the illuminance of the ground effective area is high, thereby preventing the light energy from being wasted. Meanwhile, the elevation angle of the light intensity peak value is enabled to be about 60°, and the light intensity in directions with the elevation angle being 80° and 90° is enabled not to exceed 30 cd/1,000 μm and 10 cd/1,000 lm, thereby resulting in a cut-off lamp, and effectively eliminating the glare phenomenon.

In order to meet the requirement of reducing the cost, in the example, the number of the LED light sources may be decreased, and meanwhile the illuminance on the ground and the illuminance uniformity remain unchanged, so as to optimize the distribution scheme of the LED light sources and the luminous flux. By taking the grid area 1 as an example, the light of N/E LED light sources is concentrated by the condenser lens, and after reflective light control, the grid area 1 is lighted. As shown in FIG. 5, the N/E LED light sources illuminate a sub-area according to the same ration. When several LED light sources are reduced, the illuminance of all of the sub-areas in the grid area 1 decreases according to the same proportion, the illuminance uniformity remains unchanged. When the power of the rest LED light sources is increased, the luminous flux of the single LED light source is increased, the average illuminance of all of the sub-areas of the grid area 1 remains unchanged, and the illuminance uniformity remains unchanged. According to the same design theory, when the number of the LED light sources decreases, the illuminance of any sub-area on the ground decreases according to the same proportion, the illuminance uniformity remains unchanged, and by increasing the power of the single LED light source, the illuminance uniformity of the ground effective area can remain unchanged, and the average illuminance can remain unchanged.

In summary, in the LED lamp according to the embodiment of the present invention, direct illumination of the light and abrupt change of the brightness are not involved, the design of light control of the reflective lampshade is employed, the illumination directivity of the LED lamp is improved dramatically, the unreasonable glare phenomenon is eliminated, and the illuminance uniformity is enabled to be very high. Meanwhile, based on the light source luminous flux distribution, the luminous flux received by the ground effective area is superimposition of multiple LED light sources, so that with the light distribution effect being ensured, the number of the LED light sources can be effectively decreased, and options in application between the low cost and the high lighting effect are provided. The LED lamp according to the embodiment of the present invention has the high illuminance uniformity, has no unreasonable glare, meets the application requirements of illumination environment, and has a wide range of indoor and outdoor light applications.

The objectives, technical solutions, and beneficial effects of the present invention have been described in further detail through the above specific embodiments. It should be understood that the above descriptions are merely specific embodiments of the present invention, but not intended to limit the present invention. Any modification, equivalent replacement, or improvement made without departing from the spirit and principle of the present invention should fall within the scope of the present invention.

What is claimed is:

1. A Light Emitting Diode (LED) lamp, comprising:
at least one LED light source, for emitting light; and
a reflective lampshade, comprising several reflective surfaces, wherein the reflective surfaces reflect the light emitted by the LED light source onto corresponding lighted areas respectively.

2. The LED lamp according to claim 1, further comprising:
a condenser lens, mounted in front of the LED light source, wherein the light emitted by the LED light source concentrates after passing through the condenser lens;
wherein the reflective lampshade is mounted in front of the condenser lens, and the reflective surfaces are further used to reflect the concentrated light onto the corresponding lighted areas respectively.

3. The LED lamp according to claim 2, wherein the condenser lens is further used to concentrate the light, having the beam angle of 120°, emitted by the LED light source into light having the beam angle of 10°.

4. The LED lamp according to claim 1, wherein when the number of the LED light source decreases, a high-power LED light source is used as the remaining LED light source.

5. The LED lamp according to claim 1, wherein the lighted areas have the same illuminance.

6. The LED lamp according to claim 2, wherein the lighted areas have the same illuminance.

7. The LED lamp according to claim 3, wherein the lighted areas have the same illuminance.

8. The LED lamp according to claim 4, wherein the lighted areas have the same illuminance.

9. A Light Emitting Diode (LED) lamp lighting method, comprising:
at least one LED light source emitting light; and
several reflective surfaces of a reflective lampshade reflecting the light emitted by the LED light source onto corresponding lighted areas respectively.

10. The method according to claim 9, further comprising:
a condenser lens mounted in front of the LED light source concentrating the light emitted by the LED light source; and
the reflective surfaces of the reflective lampshade further reflecting the concentrated light onto the corresponding lighted areas respectively.

11. The method according to claim 10, wherein the condenser lens further concentrates the light, having the beam angle of 120°, emitted by the LED light source into light having the beam angle of 10°.

12. The method according to claim 9, further comprising:
when the number of the LED light source decreases, using a high-power LED light source as the remaining LED light source.

13. The method according to claim 9, wherein the lighted areas have the same illuminance.

14. The method according to claim 10, wherein the lighted areas have the same illuminance.

15. The method according to claim 11, wherein the lighted areas have the same illuminance.

16. The method according to claim 12, wherein the lighted areas have the same illuminance.
